(19) United States
(12) Patent Application Publication
(10) Pub. No.: US 2017/0061421 A1
(43) Pub. Date: Mar. 2, 2017

(54) SYSTEM AND METHOD FOR PERMITTING PROXIMITY BASED FUNDS TRANSFER FROM ONE PERSON TO ANOTHER

(71) Applicant: TipFlip, LLC, Niwot, CO (US)

(72) Inventor: Jay Bennett Palmer, Niwot, CO (US)

(21) Appl. No.: 14/837,420

(22) Filed: Aug. 27, 2015

(51) Int. Cl. G06Q 20/32; G06F 3/0484; G01S 19/42; G06Q 20/40

(52) U.S. Cl. CPC G06Q 20/325; G06Q 20/40145; G06F 3/04842; G01S 19/42

(57) ABSTRACT

Provided is a system and method for permitting proximity based transfer of funds from a first person to a second person. The system includes a server and a database, the database having a user account for each user, each user account including financial transaction information, the current GPS location of the user, and for each account permitting receipt of funds, a picture of the user. An application for proximity based funds transfer for installation upon a user's first device having a CPU and GPS element is also provided. The application communicating GPS information to the server, the application having a first operating mode as a receiver permitting the receipt of funds and a second operating mode as a provider permitting the providing of funds. A First User, desiring to transfer funds to a Second User requests from the server the location of at least one Second User device within a pre-determined proximity of the First User as determined by comparing GPS records. The server sends the First User the GPS location and picture of each identified Second User within the pre-determined proximity, the First User reviewing the provided pictures, and upon a selection of a Second User picture the First User specifying an amount of funds for sending to the selected Second User. The server receives the specified amount and processes the transfer with the financial transaction information of the First User and the selected Second User. An associated method of use is also provided.

### FIELD OF THE INVENTION

The present invention relates generally to location based systems and methods for permitting one person to transfer funds, such as for a tip or reward, to another person who would like to receive such funds as a tip or reward, the transfer accomplished with a high degree of comfort that the receiving party is indeed the intended party.

### BACKGROUND

More and more, people are relying on mobile computing devices to help simplify daily life. This includes a developing aspiration to use mobile computing devices for the payment of goods and services, as the carrying of cash is often seen as cumbersome and potentially an exposure to the risk of theft.

With growing frequency, more and more people are relying on credit cards for the payment of goods and services. But credit cards are not without issues. There have been recent cases where merchant systems have been breached by hackers resulting in the theft of credit card numbers and associated data. In addition, there are often situations where a person may desire to provide funds to another, but the receiving party is simply not set up to receive credit cards.

For example, in the hospitality and service industry, it is customary to provide a tip for services provided. In many cases, when paying with a credit card the business entity provides the person who received the services with a credit slip indicating the base cost for the goods & services and a separate line for providing a tip.

Although effective, at least two issues can exist with this arrangement. The first is that the business must properly track their income and the tip/reward income separately and properly assure that the tip/reward is appropriately forwarded. If a credit card is used for the total payment, questions may arise as to if or even how the transaction fee should divided between the business and the tipped party. These issues can be complicated if the parties exchanged additional tip/reward funds outside of the general credit card transaction.

The second is that the party providing the tip/reward may not want the business to be aware of how much of a tip/reward they desire to provide the actual service provider.

While cash may be a fall back option, the use of cash once again requires the providing party to be comfortable carrying cash, and may result in the receiving party having a large volume of cash which potentially exposes them to risk such as theft, attack, anxiety, accidental lost, etc.

As computing devices in general, and mobile computing devices specifically, continue to grow in popularity and frequency of use, there have been a number of developments that strive to permit people to transfer funds for by way of their computing devices. For example, PayPal, Inc. of San Jose, Calif. provides an online system that permits one person with an account to send funds to another person with an account based on email.

But herein lie several issues for many people. First, the party sending the funds must have an account with PayPal which some people may not want to establish. Second, to transfer funds the sending party must know the email address of the receiving party and this can be problematic.

Although the receiving party may desire to receive a tip/reward, he or she may not want their patron or customer to know their email address, just as a Doctor, Lawyer, Engineer or other professional may not want his or her clients to have his or her personal home address. So at least one issue is that the receiving party must provide his or her email address in advance, and/or maintain multiple different email addresses for personal and private correspondence. But having multiple passwords and different accounts is burdensome.

Of greater issue is the fact that email addresses often have little resemblance to a person's real name—and this is often because his or her name is very common John Smith of 123 Main Street, Denver, Colo. may have an email address jsmith37@socialmedia.com while John Smith of 2020 West 4^{th} in New York, N.Y. may have an email address of jsmith73@socialmedia.com. A simple typographical error in entering the email address can have very profound results on where the desired funds are actually sent. Similarly, a person may elect to have a fun and fanciful email address—happykitty@socialmedia.com—which may be inappropriate in a professional setting. Moreover, it is very difficult to know with assurance that an email address truly is the correct email address for a new acquaintance.

Some efforts have been made to improve financial transfers between people having mobile devices. The prior art reference of Gupta U.S. Pat. No. 8,509,734 teaches an interesting system and method for location aware transaction authorization. Gupta clearly sets forth how a First User desiring to transfer funds to a Second User, or a First User desiring to request funds from a Second User, initiates the transfer request, and then a transaction authorization service utilizing a contact list or social network profile of the First User determines if the Second User is proximate to the First User. Although perhaps effective in some settings, several issues stand out. One is that the proximate party to whom funds are to be transferred to or receive from must be a known party in some searchable list associated with the first party—i.e., they are already acquaintances. This may not be desirable or even practical in all situations. Another is that the request to transfer or receive funds is made before proximity is determined, and this again permits an error—was that intended party jsmith37 in Denver or Jsmith73 in New York?

The prior art reference of Runyan US 2013/0085931 teaches Social Proximity Payments, which in detail is the ability for a party to split his or her bill with others when tendering payment to a service or entity, such as a restaurant. The teachings of Runyan are somewhat murky, but it appears that when a party having the Runyan application for splitting a tip is ready to pay a bill or make a payment, a payment provider such as PayPal is notified. The payment provider then determines the location of the user, and people known to the user are identified, such as through a user's contact list and/or the user's social network account. Those known users who are proximate to the user are presented to the user in a listing that may include a photograph and name, and the user may then selects those identified proximate persons who should share in the payment. Each of these selected proximate persons is then sent a request to make payment by the payment system. An interesting solution to bill splitting, Runyan once again is reliant on the proximate parties being known to each other, or at least known to the payment provider. Although subtle, it is also clear that Runyan is reliant on multiple parties submitting payment to a third entity—i.e., at least two people split the bill and make payment to the restaurant. Moreover Runyan is not an effective system for one party to provide funds to another.

The prior art reference of Callegari US 2003/0004743 teaches methods for providing a location based merchant presence. Specifically, the location of a consumer is determined by receiving an indication of the customer's location from a consumer device, such as a smart phone, and transmitting an electronic message regarding the merchant's presence to the consumer device only if the indicated location is the same as, overlaps with, or comes with a service area that defines the location for the merchant. Moreover, the merchant's location is actively pushed to the consumer based on detecting the consumer without the consumer having to actively search for the merchant. Although perhaps desirable for merchants, Callegari is not applicable for transfer between two parties, for aside from a panhandling situation, one person in proximity to another typically does not push him or herself on the other in the hope of receiving funds, let alone a tip/reward. More simply put, in a tip/reward setting it is the party desiring to deliver the tip/reward who is actively looking for the rewardable party.

Moreover, present systems appear focused on identifying other parties to participate in a group payment, or to whom a request for payment or an offer of services is sent. Further, present systems appear to require that in most cases the party making the request already have some level of contact or social media interaction with the other party.

In the setting of a tip/reward this may not be the case and may not be desired, let alone appropriate. Hence there is a need for a method and system that is capable of overcoming one or more of the above identified challenges.

### SUMMARY OF THE INVENTION

Our invention solves the problems of the prior art by providing novel systems and methods for permitting proximity based funds transfer from one person to another.

In particular, and by way of example only, according to one embodiment of the present invention, provided is a method of permitting proximity based transfer of funds from a first person to a second person, including: using a first instance of an application on a First User computing device having a processor and a GPS element determining the location of the First User computing device to access a remote first system having a processor and a database, the database having a user account for each user utilizing an instance of the application, each user account including financial transaction information and for at least each account permitting receipt of funds, the account including a picture of the user; querying the remote first system to identify any Second Users having second instances of the application in a receive funds mode upon Second User computing devices and a GPS location within a pre-determined geographic proximity to the First User; and for each identified Second User within the pre-determined geographic proximity to the First User, sending the location and Second User's picture to the First User device; reviewing upon the First User computing device any received pictures, and upon a selection of a Second User picture, the First User specifying an amount of funds for transfer to the selected Second User, the remote first system receiving the specified amount of funds for transfer and processing the transfer with the financial transaction information of the First User and the selected Second User.

For another embodiment, provided is a method of permitting proximity based transfer of funds from a first person to a second person including: providing a remote application for a portable computing device having at least one processor and a geographical positioning system (GPS) element, the remote application having a first operating mode as a provider and at least a second operating mode as a receiver; establishing with a first system having a processor and a database, an account for each user having a user device with an instance of the remote application installed, each account having financial transaction information and for each user device operating in receiver mode the user providing a digital picture of him or herself for his or her account, the first system receiving and recording in the database for each account the GPS location for each active user device with the remote application; wherein a First User desiring to transfer funds to another user initiates a query of the first system for geographically proximate users, the First User device requesting from the first system the location of at least one Second User device within a pre-determined geographic proximity of the First User's device as provided, the first system querying the database to identify any Second Users within the pre-determined geographic proximity to the First User's device, and for each identified Second User, sending to the First User device the location and picture of each identified Second User, the First User reviewing the provided pictures, and upon a selection of a Second User picture the First User specifying an amount of funds for transfer to the selected Second User, the first system receiving the specified amount of funds for transfer and processing the transfer with the financial transaction information of the First User and the identified Second User.

Further, in yet another embodiment provided is a system for permitting proximity based transfer of funds from a first person to a second person, including: a remote server system having a processor and a database, the database having a user account for each user utilizing an instance of an application for proximity based funds transfer, each user account including financial transaction information, the current GPS location of the user, and for at least each account permitting receipt of funds, the account including a picture of the user; at least one remote application for proximity based funds transfer (PBF App) for installation upon a remote user's first computing device having a processor and a GPS element, the remote application communicating GPS location information from the remote user device to the remote server system, the remote application having a first operating mode as a receiver permitting the receipt of funds and at least a second operating mode as a provider permitting the sending of funds; wherein upon a First User, desiring to transfer funds to a Second User, requests from the remote server the location of at least one Second User device within a pre-determined geographic proximity of the First User computing device as determined by comparing GPS location records, the remote server sending to the First User device the GPS location and picture of each identified Second User within the pre-determined geographic proximity, the First User reviewing the provided pictures, and upon a selection of a Second User picture the First User specifying an amount of funds for sending to the selected Second User, the remote server receiving the specified amount of funds for sending and processing the transfer with the financial transaction information of the First User and the selected Second User.

Still, in yet another embodiment, provided is a computer system having at least one physical processor and memory adapted by software instructions to permit proximity based transfer of funds from a first person to a second person, including: an I/O module operatively associated with an input/output device for receiving a request to establish a user account within a database, the I/O module further permitting receipt of financial transaction information and the current GPS location of the user, and for at least each account permitting receipt of funds, the account including a picture of the user; a proximity determining module for comparing the GPS locations of users as noted in the database to determine at least one subset of users within a pre-determined geographic proximity to one another; a receiver/provider module permitting a user to specify that he or she is currently in a receive funds or transfer funds mode; a display location module for displaying to a requesting First User the locations of at least a subset of Second Users who are within a pre-determined geographic proximity to the First User; a selection module permitting the First User to select at least one geographically proximate Second User, the selection module further presenting the First User with the picture of the selected Second User as provided by the database; and a funds transfer module for transferring funds as specified by the First User to the selected Second User based on the financial transaction information associated with the First User and selected Second User in the database.

### BRIEF DESCRIPTION OF THE DRAWINGS AND SUPPORTING MATERIALS

FIG. 1 illustrates a high level diagram of a system for permitting proximity based funds transfer between two users in accordance with at least one embodiment;

FIG. 2 illustrates a table of a user account details in accordance with at least one embodiment;

FIG. 3 illustrates a flow diagram for a method of permitting proximity based funds transfer between two users in accordance with at least one embodiment;

FIG. 4 illustrates conceptual examples of an application for permitting proximity based funds transfer between two users, and specifically user account initialization in accordance with at least one embodiment;

FIG. 5 illustrates conceptual examples of an application for permitting proximity based funds transfer between two users, and specifically user account review and options in accordance with at least one embodiment;

FIG. 6 illustrates conceptual examples of an application for permitting proximity based funds transfer between two users, and specifically proximity detection of Second Users in accordance with at least one embodiment;

FIG. 7 illustrates conceptual examples of an application for permitting proximity based funds transfer between two users, and specifically Second User selection and funds transfer in accordance with at least one embodiment; and

FIG. 8 is a high level block diagram of a computer system in accordance with at least one embodiment.

### DETAILED DESCRIPTION

Before proceeding with the detailed description, it is to be appreciated that the present teaching is by way of example only, not by limitation. The concepts herein are not limited to use or application with a specific system or method for proximity based funds transfer from one person to another. Thus although the instrumentalities described herein are for the convenience of explanation shown and described with respect to exemplary embodiments, it will be understood and appreciated that the principles herein may be applied equally in other types of systems and methods involving proximity based funds transfer from one person to another.

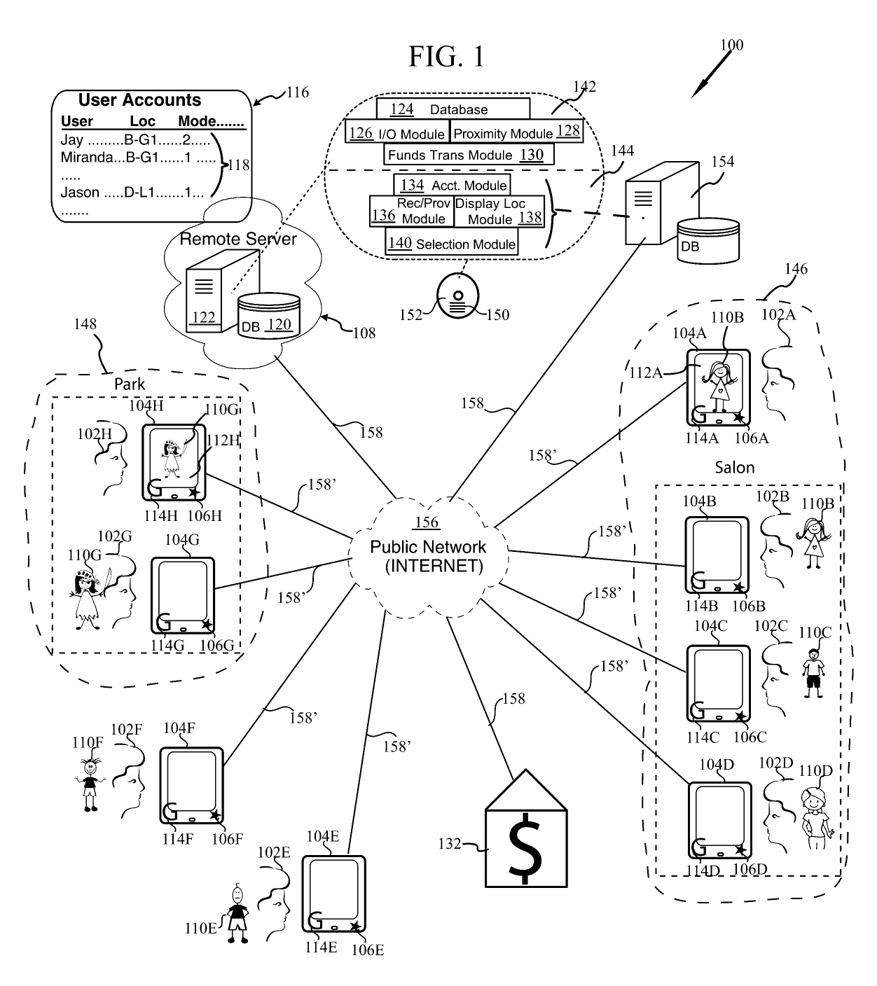

This invention is described with respect to preferred embodiments in the following description with reference to the Figures, in which like numbers represent the same or similar elements. Further, with the respect to the numbering of the same or similar elements, it will be appreciated that the leading values identify the Figure in which the element is first identified and described, e.g., element 100 appears in FIG. 1.

Various embodiments presented herein are descriptive of apparatus, systems, articles of manufacturer, or the like for systems and methods involving providing a certificate by way of a browser extension. In some embodiments, an interface, application browser, window or the like may be provided that allows the user of the computing device to direct behavior of the computing device.

Moreover, some portions of the detailed description that follow are presented in terms of the manipulation and processing of data bits within a computer memory. The steps involved with such manipulation are those requiring the manipulation of physical quantities. Generally, though not necessarily, these quantities take the form of electrical or magnetic signals capable of being stored, transferred, combined, compared and otherwise manipulated. Those skilled in the art will appreciate that these signals are commonly referred to as bits, values, element numbers or other clearly identifiable components.

It is of course understood and appreciated that all of these terms are associated with appropriate physical quantities and are merely convenient labels applied to these physical quantifies. Moreover, it is appreciated that throughout the following description, the use of terms such as “processing” or “evaluating” or “receiving” or “outputting” or the like, refer to the action and processor of a computer system or similar electronic computing device that manipulates and transforms data represented as physical (electrical) quantities within the computer system's memories into other data similarly represented as physical quantities within the computer system's memories.

The present invention also relates to apparatus for performing the operations herein described. This apparatus may be specifically constructed for the required purposes as are further described below, or the apparatus may be a general purpose computer selectively adapted or reconfigured by one or more computer programs stored in the computer upon computer readable storage medium suitable for storing electronic instructions.

To further assist in the following description, the following defined terms are provided.

“User”—typically a person or at the very least a computing device used by a person who is known to the proximity based funds transfer system, in that he or she has established a User account by providing a threshold of data, e.g. attributes to identify themselves.

“First Device”—the computing device having at least one processor that is used by the person/User desiring to provide a tip/reward to a second person/User.

“Tip/Reward”—a gratuity provided by one person to another.

“First System/Remote Server”—The system to which Users connect when establishing their initial accounts, which are in turn maintained within an account database. This database also permits a User to indicate whether he or she is set in passive mode to receive funds, and for each account set to receive funds, the User further providing his or her photograph for subsequent transmission to a party considering providing them a Tip/Reward. It is also expressly understood that the First System/Remote Server is not a payment provider or payment transaction system. The First System/Remote System is indeed provided with financial transaction information associated with each user account, however this information is used by the First System/Remote System so as to engage with a payment provider or payment transaction system on behalf of the user desiring to send a Tip/Reward to another party.

With respect to the above defined terms, it is understood and appreciated that for at least one embodiment, each module or system is implemented as a collection of independent electronic circuits packaged as a unit upon a printed circuit board or as a chip attached to a circuit board or other element of a computer so as to provide a basic function within a computer. In varying embodiments, one or more modules may also be implemented as software that adapts a computer to perform a specific task or basic function as part of a greater whole. Further still, in yet other embodiments one or more modules may be provided by a mix of both software and independent electronic circuits.

To briefly summarize, provided is a system and method for permitting proximity based transfer of funds from a First User to a Second User. In general, each user has an instance of an embodiment of the proximity reward application on his or her mobile computing device. The user desiring to provide the tip/reward is deemed the First User. The user who may receive a tip/reward are Second Users. The proximity reward application has at least two operating modes, a first mode as a provider and a second mode as a receiver. Having previously established an account with a remote first system, each user is known to the first system, had provided financial transaction information, and in the case of users who may operate in receiver mode, a current picture of themselves is also associated with their account. Each user's first device also has a location determining ability, such as GPS, that is reported to the first system during operation of the proximity reward application.

When a First User operating as a provider desires to transfer a tip/reward to a Second User, the First User's device imitates a query to the remote first system requesting the location of at least one Second User within a pre-defined geographic proximity of the First User's device. For each identified Second User proximate to the First User, the remote first system sending the First User's device the location and picture of each identified Second User. The First User may then review the identified Second Users by picture and at least first name, and select the party he or she wishes to tip/reward and specify the amount of funds for transfer. The first system then engages a payment provider with the provided financial transaction information to complete the transfer of funds.

This summary may be more fully appreciated with the respect to the following description and accompanying figures.

Turning now to the drawings, and more specifically, FIG. 1, there is shown a high level diagram of an embodiment of a system for proximity based funds transfer between two people, e.g., PBFT 100.

Moreover, PBFT 100 permits Users 102 with First User devices 104 having an instance of a proximity reward application “PBF App” 106 in network communication with a remote first system 108 to provide funds to one another. More specifically, for at least one embodiment these provided funds are gratuities, such as a Rewards/Tips. It is specifically understood and appreciated that the ability of PBFT 100 to identify proximate Users 102 and permit the transfer of funds from one user to another is not in any way based on user contact lists or pre-existing social media groups or networks. Moreover each User 102 is not required to know or otherwise enter an email address of another User 102 to receive funds—identification of a User 102 to receive funds is based on a photograph, first name, and perhaps last name initial.

Although User 102A may set up multiple transfers to different users 102, each transfer is a specific and separate transfer from one User to another User, not a one-to-many transaction. And further, the transfer is to an actual person, not an entity or business. Moreover PBFT 100 is not intended as a system for merchant payment. Further still, it is to be specifically understood and appreciated that aside from a user indicating that he or she is opting to receive transfers, the receiver's roll is for all intensive purposes passive. It is the provider who will query for proximate users, review the proximate users to identify the intended recipient and then initiate transfer to the selected user. The recipient does not receive a request for transfer or otherwise participate in the transfer process.

Rather, as is further illustrated by the discussion and accompanying figures, PBFT 100 is understood and appreciated to provide a system and method that permits one User 102 to provide a reward/tip to another User 102 based on proximity and visual confirmation of the recipient user 102 as determined by a picture 110 of the recipient as provided by the PBF App 106, and without the exchange of physical cash, checks, or the public use of a credit card.

With respect to FIG. 1, for the present example, there are shown a plurality of Users 102, of which Users 102A, 102B, 102C, 102D, 102E, 102F, 102G and 102H are exemplary. Each User 102A-102H has a corresponding User Device having at least one process, hereinafter “UD” or first device 104A-104H, each of which is understood and appreciated to be a computing device having at least one processor. Further each first device 104 has a visual display screen 112.

In addition, for at least one embodiment, each first device has a location determining element such as a Global Positioning System “GPS” element 114. As discussed below, if a GPS element 114 is not included, or is hampered in performance, the location of the first device 104 may optionally be determined by other means.

Moreover, each first device 104 has been illustrated as a wireless smart phone, but may alternatively comprise a portable computer or data assistant device that is capable of portable wireless communication using WiFi networks, wireless network access points, cellular networks, GPS transmissions, and or other such technologies. Moreover, for at least one embodiment, the user devices 104A-104H are smart phone devices such as, but not limited to the Apple Computers iPhone® or Samsung Android® device.

As is also shown in FIG. 1, remote first system 108 has a record 116 of the details for each user account 118 for each User 102. In varying embodiments, this record 116 may be a component integrated with remote first system 108 or a remote database to which the remote first system 108 has access rights when and as needed. For the present example as shown, the database 120 supporting record 116 is shown as a component of first system 108.

For at least one embodiment, the remote first system 108 is understood to be a computing device including at least one microprocessor, memory and the like which are adapted by hardware or software to permit data exchange over a network. In addition, for at least one embodiment, the remote first system 108 has a physical computer system 122 (including at least one microprocessor, memory, I/O device(s) and the like) including database 120 for maintaining the user 102 records 112 and is at least in part adapted to provide remote first system 108 in part by a database module 124, an I/O module 126, a proximity module 128, and a funds transfer module 130. In addition, each User's 102 first device 104 is adapted at least in part by an account module 134, a receive/provide module 136, a display location module 138 and a selection module 140.

With respect to FIG. 1, PBFT 100 may be further appreciated to be a Client & Server type of computer system. Moreover, the server component 142 is appreciated to be provided by the database module 124, the I/O module 126, the proximity module 128 and the funds transfer module 130. The client component 144, aka PBF App 106, is provided by the account module 134, the receive/provide module 136, the display location module 138 and the selection module 140

The I/O module 126 is structured and arranged to receive data from the first devices 104, such as but not limited to account setup requests, account log in and log out actions, operation mode selection, a current digital picture, location information, financial transaction information, and of course a request to provide funds to another User 102. The I/O module 126 will record and update this information within the database module 126 which is of course structured and arranged to operate as repository for PBST 100 data.

The funds transfer module 130 is structured and arranged to utilize User provided financial transaction information so as to communicate with a payment provider 132 to effectuate the transfer of funds from one User 102 to another. The proximity module 128 is structured and arranged to review the database 120 and determine which, if any Users are within a pre-determined proximity to a First User considering providing a reward/tip to Second User. In general this pre-defined proximity is user selectable. In a dense city setting, the initial pre-defined proximity may be 500 feet whereas in a more open rural area the pre-defined proximity may be 1000 feet.

The account module 134 is structured and arranged to permit the User 102 to initialize his or her account with the remote first system 108, and subsequently to update his or her account details including but not limited to, financial transaction information, a review of history, login & log out. For at least one embodiment the account module 134 may also permit the User to submit a current photo of him or herself, such as may be taken with a camera (not shown) of the first device 104.

The receive/provide module 136 is structured and arranged to permit a user to indicate at least one of two modes of operation, a first operating mode as a receiver of funds and at least a second operation mode as a provider of funds. For at least one embodiment, a User 102 may designate that he or she desired to operate in both modes substantially concurrently—which is to say that a User 102 may set his or account to permit both the receipt of funds from another User as well as to transfer funds to another User 102.

The display location module 138 is structured and arranged to display to the First User 102 (i.e., he or she who is using the first device 104) upon the first device 104 the current location of the First User 102 as determined by the location element of the first device 104. For the initial example and ease of illustration and discussion, an initial First User is identified to be User 102A with Second Users 102B-102D being within a pre-determined proximity 146 to the First User 102A and Second Users 102E-102H being beyond the pre-determined proximity 146 to the First User 102A.

As will be further described below, for this first example, users 102B-102D work in a salon. User 102A has just received a haircut from User 102B and desires to provide her with a reward/tip separate and apart from the payment he renders to the salon as a business establishment. User 102A is presented with pictures 110 of Users 102B-102D and from them he has selected the picture 110B for User 102B who provided his services.

In addition, the display location module 138 is further structured and arranged to display to the First User 102A upon the first device 104A the location of any Second Users 102A identified by the remote first system 108 as being within a pre-defined proximity to the First User 102A—such that First User 102A sees the locations of Second Users 102B-102D. For at least one embodiment, the display location module 138 is optionally configured to interact with a third party mapping application such as, but not limited to Apple® Maps or Google Maps® so as to advantageously provide the User 102A with a known and familiar interface underlying the graphical display of the User 102A and other Second Users 102B-102D who are within the pre-determined proximate distance.

For at least one embodiment the pre-defined proximity is based off of the scale that the User 102 has selected for the map display on the first device 104. In other words, if the User 102 has selected to enlarge or reduce the map to show the map with a scale of 200 feet, the pre-determined proximity is about 200 feet, as may be desired in a dense metropolitan setting.

In yet another instance, the user may select a map scale of about ¼ mile, in which case the pre-determined proximity is about ¼ mile. For at least one embodiment an outer bound may be established, such as 5 miles, as proximity to the Second User is an important aspect of a valid confirmation by the First User 102A that the selected Second User is indeed the desired Second User.

The Selection module 140 is structured and arranged to interact with the I/O system of the first device so as to permit the First User 102A to select one of the displayed Second Users 102B-102D who is proximate to the First User 102A and further indicate the amount of the reward/tip that the First User 102A wishes to transfer to the selected Second User 102B.

Use of PBFT 100 is of course not limited to a brick and mortar establishment, or even the context of actual services. For another example, User 102H is at a party in a park with his daughter. User 102G is dressed in costume and entertaining children. User 102H is so pleased with how happy his daughter is with a balloon pirate sword that he activates his first device 104H and more specifically PBF App 106H to see if User 102G is also a user of PBFT 100. In this second example, User 102H is First User 102H. Second User 102G is determined by PBFT 100 to be within his proximity 148, and in this example is the only other User 102 within his proximity 148, Users 102A-102F being beyond the proximity 148.

In addition, to further demonstrate the element of proximity between Users 102 so as to transfer funds, Users 102E and 102F are both shown to participate in PBFT 100, however neither user is within a pre-determined proximity of any other participating User 102. As such neither User 102E nor User 102F is permitted to transfer funds to another User, or for that matter receive funds from another User 102 as the proximity element has not been satisfied for PBFT 100.

As User 102G has updated her picture 110G to show herself in her current costume, First User 102G is confident that he has identifier her properly as the delightful entertainer in the park. First User 102G then selects her and indicates the amount of funds he wishes to transfer to User 102H as a reward for making his day in the park so enjoyable. This transfer of funds from First User 102H to Second User 102G may be performed without Second User 102G even being aware of the reward until she later checks her first device 104G and learns of the gracious reward from User 102H.

Returning to the discussion of modules for an embodiment of PBFT 100, it is understood and appreciated that in varying embodiments, the elements, e.g., database module 124, the I/O module 126, the proximity module 128, and the funds transfer module 130 for the Server side of PBFT 100, and the account module 134, receive/provide module 136, display location module 138 and selection module 140 for the client side of PBFT 100 may be provided as software routines, hardware elements, and/or combinations thereof. Although shown distinctly for ease of illustration and discussion, in varying embodiments, it is understood and appreciated that one or more of these elements may be combined and/or further subdivided into a number of sub-elements or sub-modules.

With respect to FIG. 1, the elements of the database module 124, the I/O module 126, the proximity module 128, and the funds transfer module 130 for the Server, and the account module 134, receive/provide module 136, display location module 138 and selection module 140 for the Client, are conceptually illustrated in the context of an embodiment for a computer program 150. Such a computer program 150 may be provided upon a non-transitory computer readable media, such as an optical disc 152, or USB drive (not shown), having encoded thereto an embodiment of a program for permitting proximity based transfer of funds from one person to another.

The computer executable instructions for computer program 150 are provided to the remote first system 108, i.e., computer system 122. During operation of PBFT 100 the computer program 150 for permitting proximity based transfer of funds from one person to another may be maintained in active memory for enhanced speed and efficiency. In addition, the computer program 150 for permitting proximity based transfer of funds from one person to another may also be operated within a computer network and may utilize distributed resources.

For at least one embodiment the client side modules 144, i.e. the account module 134, receive/provide module 136, display location module 138 and selection module 140 that provide PBF App 106 may be provided directly to desiring Users 102 by the remote first system 108. For at least one alternative embodiment, these modules, comprising PBF App 106 are made available from a third party 154 such as, but not limited to the Apple® App Store, or Google® Play, or such other third party application provider. And for yet another embodiment, the account module 134, receive/provide module 136, display location module 138 and selection module 140 may be separately provided on a non-transitory computer readable media providing PBF App 106 for upload to such a third party application provider or even to User 102 directly for direct installation upon his or her first device 104.

Moreover, for at least one embodiment, PBFT 100 may be summarized an I/O module 126 operatively associated with an input/output device for receiving a request to establish a user account within a database 120, the I/O module further permitting receipt of financial transaction information and the current GPS location of the User 102, and for at least each account permitting receipt of funds, the account including a picture 110 of the User 102; a proximity determining module 128 for comparing the GPS locations of Users 102 as noted in the database 120 to determine at least one subset of users within a pre-determined geographic proximity to one another; a receiver/provider module 134 permitting a User 102 to specify that he or she is currently in a receive funds or transfer funds mode; a display location module 136 for displaying to a requesting First User the locations of at least a subset of Second Users 102B who are within a pre-determined geographic proximity to the First User 102A; a selection module 140 permitting the First User 102A to select at least one geographically proximate Second User 102B, the selection module 140 further presenting the First User 102A with the picture 110 of the selected Second User 102B as provided by the database 120; and a funds transfer module 130 for transferring funds as specified by the First User 102A to the selected Second User 102B based on the financial transaction information associated with the First User 102A and selected Second User 102B in the database 120.

Returning to FIG. 1, in varying embodiments, one or more elements of PBST 100 may be directly connected to one another, if not physically integrated with each other, but it is understood and appreciated that in most instances the incorporation of the Internet 156 and communication links 158 involving the Internet 156 as a common means of communication and information exchange is within the scope of the present invention.

It is also to be understood and appreciated that the elements of PBFT 100 need not maintain continual communication links 158. In other words, Users 102 may log on or off, and thus establish a link to remote first system 108, the remote first system 108 may be on or off line at different times for different reasons. However, in general it is understood and appreciated that for the expected operation either the elements shown or suitable substitutions are understood and appreciated to be available for expected operation of PBFT 100.

As noted above, for at least one embodiment the first devices 102 are likely to be smart phone devices communicating with remote first system 108 at least in part by wireless communication links 158′. As also noted above, for at least one embodiment, each first device has a GPS element 114 that is operable to provide the location of the first device 104 to the remote first system 108. In some cases, even where the first device 104 has a GPS element 114, technical issues may frustrate the determination of location by use of the GPS element 114.

Moreover, although for at least one embodiment it is desirable for each first device 104 to determine and report its location, for at least one alternative embodiment additional methodologies may be employed to determine first device 104 location, or perhaps even to verify the first device 104 location. For example, pre-complied databases of cellular network IP addresses may be consulted to approximate location. As another example, when using a cellular network it is possible to identify the particular cell tower to which the first device 104 is connected and thereby deduce an approximate geographic location. Triangulation using two or more cell towers may permit an even more refined approximation. In yet other instances the location of the WiFi hotspot or access point may be used to approximate location. Moreover, a variety of techniques are understood and adaptable to determine approximate, if not substantially absolute position of first device 104.

With respect to the present invention of PBFT 100, it is understood and appreciated that it is not necessary for the location of a first device 104 to be absolutely known, or even known in substantially real time. Whether the location of a first device 104 is reported directly or deduced, it is the point of being able to determine at least general location that is in turn useful to determine general proximity as between first devices 104.

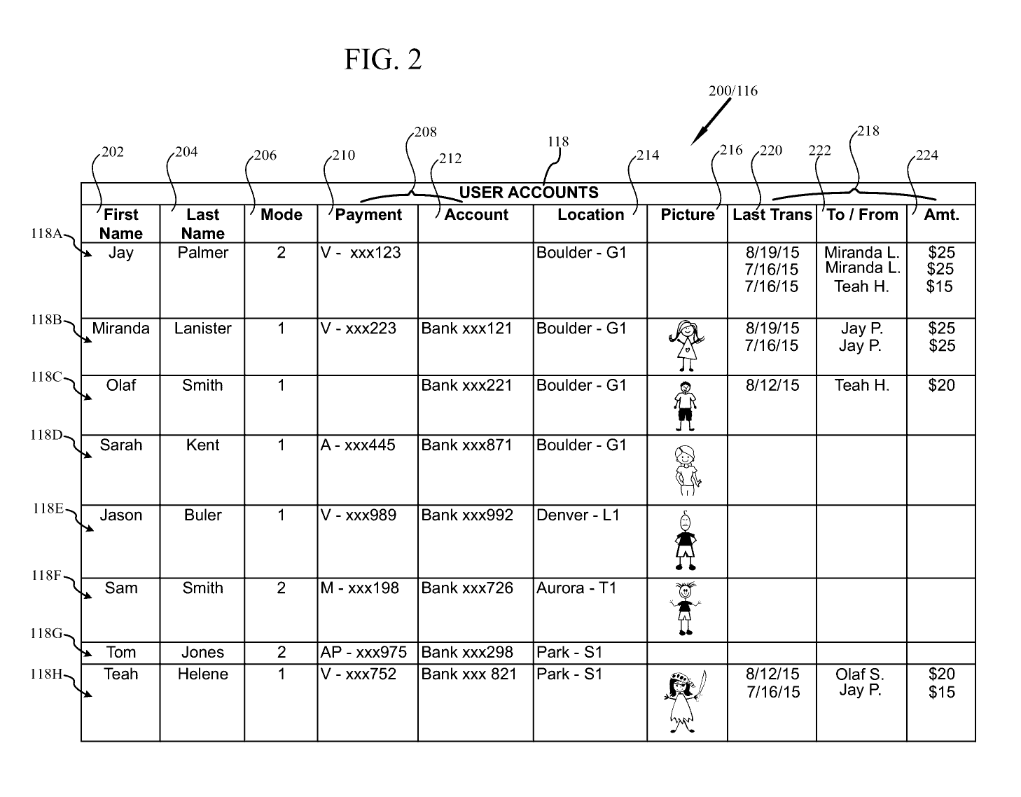

FIG. 2 provides a further example of record 116 as shown by exemplary table 200. Moreover, table 200 provides correlated user account 118 records regarding the Users 102 known to PBFT 100, including, but not necessarily limited to at least the first name 202, the last name 204, the operating mode 206, financial transaction information 208 including payment option 210 and bank account 212, the last known physical location 214, and for at least those Users 102 who opt to receive funds a digital picture 216.

Of course in varying embodiments additional information may be recorded as well, such as but not limited to an account username and password, not presently shown. In addition, for at least one embodiment table 200 may optionally also record the history of transactions 218 for each User 102, i.e., the date of the last transaction 220, who the transaction was from or to 222 and the amount 224.

With respect to location 212, for ease of illustration and discussion this data has been shown as general reference place names, and such encoding may be used for general security purposes to partially mask the true locations of Users 102 from prying third parties. As for one embodiment the location of each user is determined by GPS element in each first device, the location data may be traditional latitude and longitude figures or GPS coded coordinates.

Moreover, for at least one embodiment, PBFT 100 may be summarized as a system for permitting proximity based transfer of funds from a First User 102A to a second 102B. PBFT 100 includes a remote server system 108 having a processor and a database 120, the database 120 having a user account 118 for each User 102 utilizing an instance of PBF App 106 for proximity based funds transfer. Each user account 118 including financial transaction information 208, the current location 214 of the user 102, and for at least each account permitting receipt of funds, the account including a picture 216 of the User 102. Also provided is at least one remote application for proximity based funds transfer (PBF App 106) for installation upon a remote user computing device, e.g. first device 104, having a processor and a GPS element 114, the PBF App 106 communicating GPS location information from the remote user device 104 to the remote first system 108, the PBF App 106 having a first operating mode as a receiver permitting the receipt of funds and at least a second operating mode as a provider permitting the sending of funds.

Upon a First User 102A, desiring to transfer funds to a Second User 102D, requests from the remote server 108 the location of at least one Second User device 104B-D within a pre-determined geographic proximity of the First User 102A computing device as determined by comparing GPS location records 214, the remote server 108 sending to the First User device 104A the GPS location 214 and picture 110/216 of each identified Second User 102B-102D within the pre-determined geographic proximity. The First User 102A may then review the provided pictures 216, and upon a selection of a Second User 102B picture 110B the First User 102A specifying an amount of funds for sending to the selected Second User 102B, the remote server 108 receiving the specified amount of funds for sending and processing the transfer with the financial transaction information 208 of the First User 102A and the selected Second User 102B.

Indeed, PBFT 100 permits a First User 102A to transfer funds to a Second User 102B without a physical exchange of cash between the parties. As such, each User of PBFT 100 may potentially enjoy a greater sense of security in not having to carry or receive cash. In addition, as PBFT 100 operates privately between the involved Users 102, other parties are blind to the transfer of funds. Not only does this provide a potential advantage to an employer in the form of reduced book keeping for tips, but the extent of any reward or tip is a private matter between the users. This privacy may help avoid work place animosity where one User 102 is rewarded differently from another User 102.

Of course it should be realized that if a receiving User feels that he or she should share the receive transfer of funds with his or her co-workers, the principles of PBFT 100 may be once again applied with the former Second User now acting in the roll of the First User and transferring funds to his or her selected co-workers as Second Users.

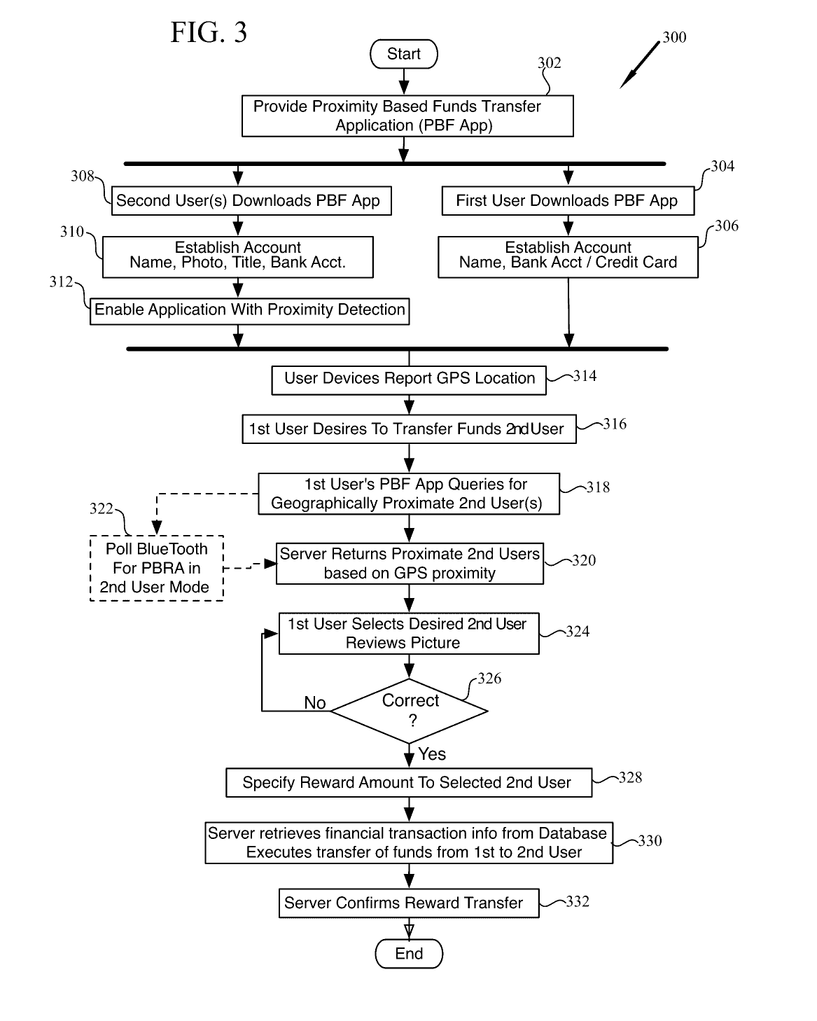

Having described embodiments for PBFT 100 as shown with respect to FIGS. 1 and 2, other embodiments relating to various methods of proximity based funds transfer will now be discussed with respect to an exemplary method 300 shown in FIG. 3 in connection with FIGS. 1 and 2 and 4-7. It will be appreciated that the described method need not be performed in the order in which it is herein described but that this description is merely exemplary of at least one method for advantageously achieving proximity based funds transfer between two Users 102.

In general, method 300 commences with providing an embodiment of a PBF App 106 to desiring Users 102, block 302. As noted above, PBF App 106 provides at least two operating modes, one as a receiver of funds and one as a provider of funds. Although a User 102 may certainly opt to enjoy the flexibility of operating in either mode, one or more Users 102 may choose to operate in only one mode—either as a receiver or as a provider. For ease of illustration and discussion, method 300 has been illustrated so as to show specific User rolls.

More specifically, a First User, i.e., user 102A, downloads the PBF App 106, block 304, and installs it upon first device 104A. User 102A then proceeds to use PBF App 106A to establish an account with remote first system 108, block 306. Similarly, a Second User, i.e., user 102B downloads the PBF App 106, block 308 and installs it upon first device 104B. User 102B then proceed to use PBF App 106B to establish an account with remote first system 108, block 310. As User 102B desires to receive funds through the use of PBFT 100 and more specifically PBF App 106B, User 102B also provides a current photo 110B.

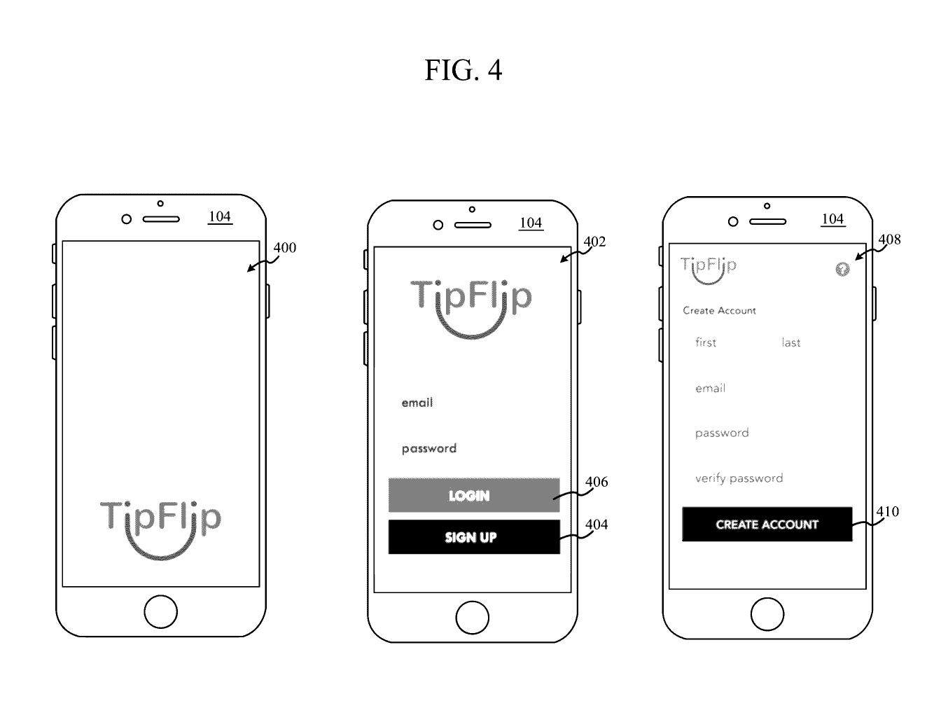

FIG. 4 provides conceptual illustrations for an embodiment of PBF App 106 as it may appear in active use upon a user device 104. Upon startup there is an initial screen 400, followed by an account login or setup screen 402. For the present example, both First User 102A and Second User 102B are establishing accounts, and therefore would select the Sign Up option provided by button 404. Upon subsequent use of PBF App 106 each would simply provide his or her password and email and login via button login 406.

Each User 102 is then provided with a basic Create Account screen 408, where as shown for the present example, each new User 102 is requested to provide their first name, last name, email address and a password. With this information provided the user presses Create Account button 410.

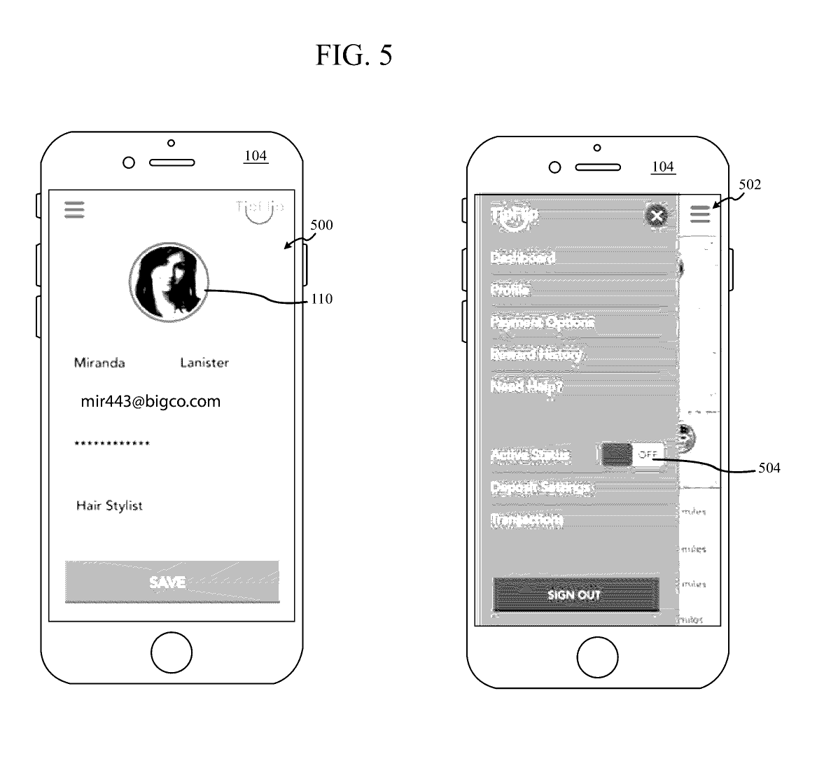

With the basics of the account now established, for at least one embodiment the User 102B is now advanced to an account summary page 500 as shown in FIG. 5, where he or she may also upload a photo 110 and edit the displayed size. Now the User 102B is ready to use PBF App 106, and more specifically PBFT 100.

As shown in account options screen 502, the change in mode is shown with an Active Status switch 504, presently shown as “Off”, indicating that this particular User 102 is in the first operating mode as a provider of funds. If switched to “On” this particular User 102 will be in the second operating mode as a receiver of funds.

With respect to method 300 as shown in FIG. 3, the Second User 102B is opting to receive funds so she will enable the Active Status switch 504 to “On”, block 312. If a User 102 opting to select the “On” setting for active status switch 504 has not already uploaded a self photo by way of PBF App 106 to the remote first system 108, the User 102 will then be directed to do so.

Method 300 now continues with at least one First User 102A operating in the first mode as a provider and at least one Second User 102B operating in the second mode as a receiver, block 314, and for at least Second User 102B her location is reported to remote first system 108. For at least one embedment, these reports of location may be made at about regular intervals. For yet another embodiment, these reports of location may be made when the user device 104 has moved outside of the last reported location by a specified distance.

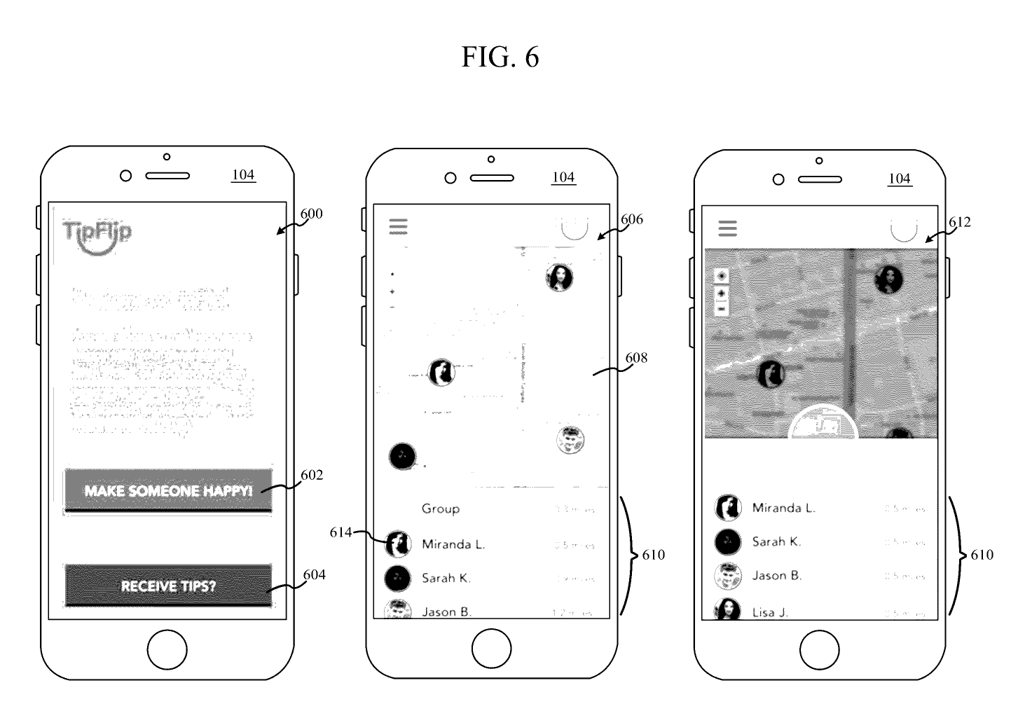

At some point in time, such as after having received grooming services, the First User 102A desires to transfer funds to another user 102, block 316. As shown in FIG. 6, the action screen 600 provides one of two option—“Make Someone Happy” 602 correlating to the first operating mode of being a provider and Receive Tips” 604. In varying embodiments, pressing the button to receive tips will change the Active Status switch 504 to ON, if it is not already in that position. Pressing Make Someone Happy” 602 will in at least one embodiment change the Active Status Switch 414 to off, and for yet another embodiment simply permit the User to transfer funds based on proximate location, but not alter the Active Status switch from ON, if the User is primarily interested in being a receiver.

Using his PBF App 106A, First User 102A selects the Make Someone Happy” 602 button which initiates a query for Second Users 102 who are within a pre-determined proximity, block 318. If the location of the First User 102A is not already known to the remote first system, that location will be included with the query. As indicated in FIG. 1 there are three (3) users 102 who are within the pre-defied proximity to User 102A, and in block 320, the remote server 108 returns the results of this query to User 102A.

As is shown in FIG. 6, the results of the proximity query, block 320 are displayed to User 102A as mapping screen 606, showing a map 608 of the proximate area about the First User 102A and a listing 610 of the proximate Second Users 102B-102D. As previously noted, for at least one embodiment, PBFT 100 utilizes familiar mapping software and superimposes the query results. The location of the First User 102A may also optionally be displayed.

For at least one embodiment, PBFT 100 may permit Users 102 to indicate their general place of employment, such that when a query is returned, the location of the business may also be displayed, and if selected, the employees working for the business will be collectively grouped as shown in screen 612. Such sub-grouping of proximate Second Users may be advantageous in crowded areas where a plurality of Second Users proximate to the First User are determined.

For at least one optional embodiment, PBFT 100 may also employ Bluetooth or other ad hoc near field technology to further verify the proximate existence of one or more Second Users, optional block 322.

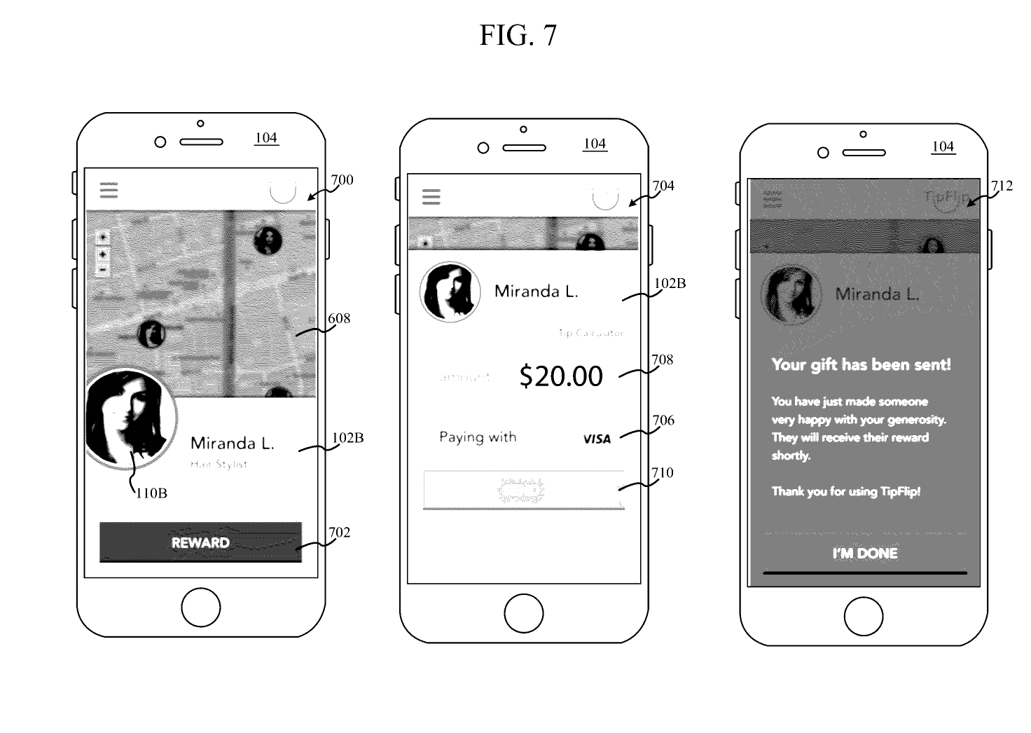

With the list of proximate Second Users 102B-102D now provided as shown in screen 606, First User 102A may review each to verify the proper identity of the Second User he wishes to reward, block 324 For at least one embodiment as shown in screen 606, small thumbnails 614 may be included. When First User 102A selects a possible Second User, such as by tapping the listed name, the First User is provided with an enlarged picture and name as shown in FIG. 7, proximate Second User screen 700.

The use of a picture permits the First User an enhanced degree of assurance that he or she has identified the proper party. As Users 102 may update their pictures 110 as often as they like, they may ensure that the current picture provided by PBFT 100 and method 300 is current for how they appear each day. For the second example presented in FIG. 1 of User 102H entertaining children in the park and appearing in costume, this ability to provide a very current photo may be highly beneficial for both the Second User 102H and the querying First User 102G, as Second User 102H may appear very differently out of costume.

Moreover, returning to the first example, First User 102A reviews one or more returned Second User photos so as to identify the correct Second User 102B, decision 326. If the picture does not match the desired Second User 102B, the First User 102A simply selects another Second User, block 324.

When First User 102A has identified his stylist, Second User 102B, he selects the Reward button 702. Method 300 now advances to permit First User 102A to specify the amount of funds to be transferred to selected Second User 102B as shown in transfer screen 704, block 328. In addition, for at least one embodiment, the transfer screen 704 may optionally permit the First User 102A to select his or her form of payment 706, options previously provided by the User 102A to the remote first system, such as but not limited to, one or more credit cards, a PayPal account, Apple Pay, Google Wallet, a bank account, credit union account, or such other financial account from which funds may be paid on the User's behalf. As shown in FIG. 7, and specifically reward screen 704, First User 102A has specified an amount of $20.00, 708.

With the amount for transfer now specified, First User 102A selects the Send button 710, and PBF App 106 sends the specified amount to the remote first system 108. The remote first system 108 retrieves the financial transaction information from the database 120 and executes the transfer of funds from the First User 102A to the selected Second User 102B, block 330.

Upon confirmation of the transfer, the remote first system 108 provides a confirmation to at least the First User 102A as shown in screen 712, block 332.

To summarize, for at least one embodiment, provided is a method of permitting proximity based transfer of funds from a First User 102A to a selected Second User 102B, the method including using a first instance of an application, e.g., PBF App 106, on a First User computing device 104 having a processor and a GPS element 114 determining the location of the First User computing device to remotely access a first system 108 having a processor and a database 120, the database 120 having a user account 118 for each User 102 utilizing an instance of the application 106, each user account 118 including financial transaction information 210 and for at least each account permitting receipt of funds, the account including a picture 110 of the user 102.

The method further includes querying the first system 108 to identify any Second Users 102B-102D having second instances of the application 106 in a receive funds mode upon Second User computing devices 104 and a GPS location within a pre-determined geographic proximity to the First User 102A. For each identified Second User, e.g. Second Users 102B-102D, within the pre-determined geographic proximity to the First User 102A, sending the location and Second User's picture(s) 110 to the First User device 104. The method continues with the First User 102A reviewing upon the First User computing device 104A any received pictures, and upon a selection of a Second User Picture 110B, the First User 102A specifying an amount of funds for transfer to the selected Second User 102B. The remote first system 108 receiving the specified amount of funds for transfer and processing the transfer with the financial transaction information 210 of the First User 102A and the selected Second User 102B.

Indeed method 300 may also be summarized for at least one embodiment as a method of permitting proximity based transfer of funds from a first person to a second person including: providing a remote application, e.g. PBF App 106, for a portable computing device 104 having at least one processor and a geographical positioning system (GPS) element 114, the remote application 106 having a first operating mode as a provider and at least a second operating mode as a receiver. The method further includes establishing with a remote first system 108 having a processor and a database 120, an account 118 for each User 102 having a user device 104 with an instance of the remote application 106 installed, each account 118 having financial transaction information 210 and for each user device 104 operating in receiver mode the user 102 providing a digital picture 110 of him or herself for his or her account 118, the remote first system 108 receiving and recording in the database 120 for each account 118 the GPS location for each active user device 104 with the remote application 106.

A First User 102A desiring to transfer funds to another user 102 initiates a query of the remote first system 106 for geographically proximate users 102, the First User device 104 requesting from the remote first system 108 the location of at least one Second User device 104 within a pre-determined geographic proximity of the First User's device 104A as provided, the remote first system 108 querying the database 120 to identify any Second Users, e.g. Second Users 102B-102D, within the pre-determined geographic proximity to the First User's device 104A, and for each identified Second User, sending to the First User device 104A the location and picture 110 of each identified Second User 102B-102D. The First User 102A then reviews the provided picture(s) 110, and upon a selection of a Second User picture 110B the First User 102A specifying an amount of funds for transfer to the Selected Second User 102B, the remote first system 108 receiving the specified amount of funds for transfer and processing the transfer with the financial transaction information 210 of the First User 102A and the selected Second User 102B.

Moreover, it is appreciated that PBFT 100 and method 300 advantageously permit the First User 102A to easily identify and select a Second User 102B while maintaining professional decorum as the First User 102A and selected Second User 102B need not be “friends” on a social network, members of each other's contact lists, or otherwise socially known to one another outside of the context of the services and friendship that may exist at the salon. Indeed, other than specifying her instance of PBF App 106B to be in receive mode, Second User 102B is certainly not actively soliciting for a reward or tip. And in an advantageous departure from many of the known prior art systems, the First User does not need to send a request to the selected Second User 102B before transferring funds to her.

Indeed the transfer of funds as between the First User 102A and the selected Second User 102B can be an entirely private affair between the parties. The business establishment does not need to know of the transfer let alone the amount, and therefore may enjoy reduced overhead in accounting. The other employees in the establishment are likewise unaware of the details of any transfer and therefore may feel reduced competition amongst themselves, resulting in a more harmonious working environment. For at least one optional embodiment, the First Party 102A may be provided with an option to provide the transfer of funds anonymously.

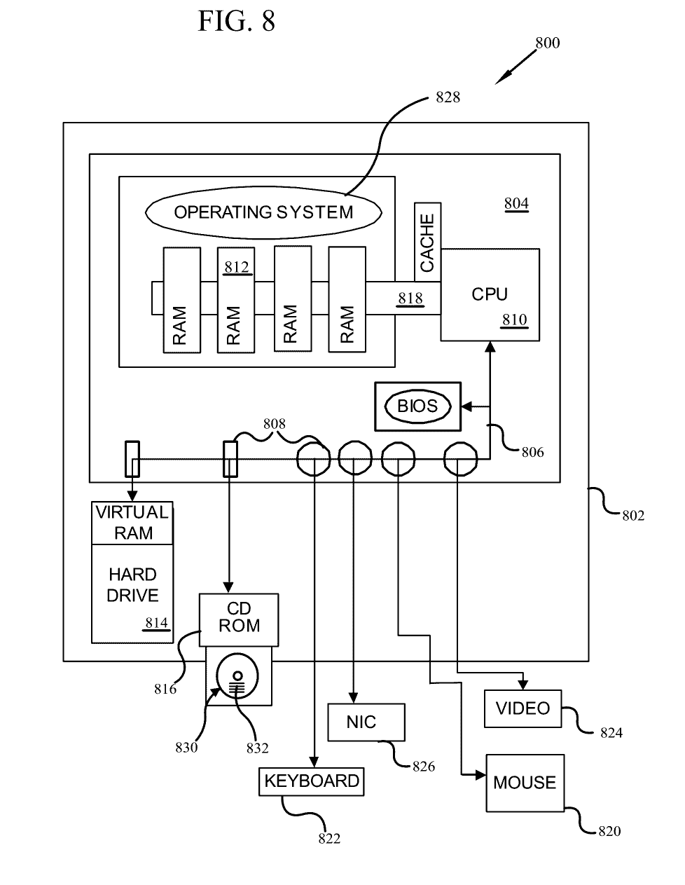

With respect to the above description of the system and method for permitting proximity based funds transfer, it is understood and appreciated that the method may be rendered in a variety of different forms of code and instruction as may be used for different computer systems and environments. To expand upon the initial suggestion of the Users 102 First Devices 104 and the remote first system 108 being computer systems adapted to their specific roles, FIG. 8 is a high level block diagram of an exemplary computer system 800 such as may be provided for one or more of the elements comprising a First Device 104, the remote first system 108, payment provider 132, and third party 154 whether provided as distinct individual systems or integrated together in one or more computer systems.

Computer system 800 has a case 802, enclosing a main board 804. The main board 804 has a system bus 806, connection ports 808, a processing unit, such as Central Processing Unit (CPU) 810 with at least one microprocessor (not shown) and a memory storage device, such as main memory 812, hard drive 814 and CD/DVD ROM drive 816.

Memory bus 818 couples main memory 812 to the CPU 810. A system bus 806 couples the hard disc drive 814, CD/DVD ROM drive 816 and connection ports 808 to the CPU 810. Multiple input devices may be provided, such as, for example, a mouse 820 and keyboard 822. Multiple output devices may also be provided, such as, for example, a video monitor 824 and a printer (not shown). As computer system 800 is intended to be interconnected with other computer systems in the PBFT 100 a combined input/output device such as at least one network interface card, or NIC 826 is also provided.

Computer system 800 may be a commercially available system, such as a desktop workstation unit provided by IBM, Dell Computers, Gateway, Apple, or other computer system provider. Computer system 800 may also be a networked computer system, wherein memory storage components such as hard drive 814, additional CPUs 810 and output devices such as printers are provided by physically separate computer systems commonly connected together in the network.

Those skilled in the art will understand and appreciate that the physical composition of components and component interconnections are comprised by the computer system 800, and select a computer system 800 suitable for one or more of the computer systems incorporated in the formation and operation of PBFT 100.

When computer system 800 is activated, preferably an operating system 828 will load into main memory 812 as part of the boot strap startup sequence and ready the computer system 800 for operation. At the simplest level, and in the most general sense, the tasks of an operating system fall into specific categories, such as, process management, device management (including application and User interface management) and memory management, for example. The form of the computer-readable medium 830 and language of the program 832 are understood to be appropriate for and functionally cooperate with the computer system 800.

Moreover, variations of computer system 800 may be adapted to provide the physical elements of one or more components comprising each First Device 104, the remote first system 108, payment provider 132, third party 154, and the switches, routers and such other components as may be desired and appropriate for the methods and systems of providing proximity based funds transfer between two Users 102.

Changes may be made in the above methods, systems and structures without departing from the scope hereof. It should thus be noted that the matter contained in the above description and/or shown in the accompanying drawings should be interpreted as illustrative and not in a limiting sense. Indeed many other embodiments are feasible and possible, as will be evident to one of ordinary skill in the art. The claims that follow are not limited by or to the embodiments discussed herein, but are limited solely by their terms and the Doctrine of Equivalents.

What is claimed is:

1. A method of permitting proximity based transfer of funds from a first person to a second person, comprising:
using a first instance of an application on a First User computing device having a processor and a GPS element determining the location of the First User computing device to access a remote first system having a processor and a database, the database having a user account for each user utilizing an instance of the application, each user account including financial transaction information and for at least each account permitting receipt of funds, the account including a picture of the user;
querying the remote first system to identify any Second Users having second instances of the application in a receive funds mode upon Second User computing devices and a GPS location within a pre-determined geographic proximity to the First User; and
for each identified Second User within the pre-determined geographic proximity to the First User, sending the location and Second User's picture to the First User device;
reviewing upon the First User computing device any received pictures, and upon a selection of a Second User picture, the First User specifying an amount of funds for transfer to the selected Second User, the remote first system receiving the specified amount of funds for transfer and processing the transfer with the financial transaction information of the First User and the selected Second User.

2. The method of claim 1, wherein the pre-determined geographic proximity is about 500 feet.

3. The method of claim 1, wherein upon a transfer of funds, the first system notifies both the First User and the selected Second User of the transfer of funds.

4. The method of claim 1, wherein the use of pictures permits the First User to visually confirm the selected Second User as the desired party to receive the transferred funds.

5. The method of claim 1, wherein the transfer of funds are provided as a tip.

6. The method of claim 1, wherein the First User computing device and the Second User computing device are each a smart phone.

7. The method of claim 1, wherein the Second User updates his or her photo daily.

8. The method of claim 1, further including near field network connection between the First User computing device and Second Users having second instances of the application in receive funds mode within the pre-determined geographic proximity.

9. The method of claim 1, wherein the geographic locations of the First User and at least a subsection of the Second Users within the pre-determined geographic proximity are displayed to the First User through a mapping application.

10. The method of claim 9, wherein the mapping application has a user selected resolution, the pre-determined geographic proximity to the First User set at about the user selected resolution of the mapping application.

11. The method of claim 1, wherein the GPS location of each Second User having a second instance of the application in receive funds mode is sent to the first system at regular time intervals.

12. A method of permitting proximity based transfer of funds from a first person to a second person comprising:
providing a remote application for a portable computing device having at least one processor and a geographical positioning system (GPS) element, the remote application having a first operating mode as a provider and at least a second operating mode as a receiver;
establishing with a remote first system having a processor and a database, an account for each user having a user device with an instance of the remote application installed, each account having financial transaction information and for each user device operating in receiver mode the user providing a digital picture of him or herself for his or her account, the remote first system receiving and recording in the database for each account the GPS location for each active user device with the remote application;
wherein a First User desiring to transfer funds to another user initiates a query of the remote first system for geographically proximate users, the First User device requesting from the remote first system the location of at least one Second User device within a pre-determined geographic proximity of the First User's device as provided, the remote first system querying the database to identify any Second Users within the pre-determined geographic proximity to the First User's device, and for each identified Second User, sending to the First User device the location and picture of each identified Second User, the First User reviewing the provided pictures, and upon a selection of a Second User picture the First User specifying an amount of funds for transfer to the selected Second User, the remote first system receiving the specified amount of funds for transfer and processing the transfer with the financial transaction information of the First User and the identified Second User.

13. The method of claim 12, wherein the pre-determined geographic proximity is about 500 feet.

14. The method of claim 12, wherein upon a transfer of funds, the first system notifies both the First User and the selected Second User of the transfer of funds.

15. The method of claim 12, wherein the use of pictures permits the First User to visually confirm the selected Second User as the desired party to receive the transferred funds.

16. The method of claim 12, wherein the transfer of funds are provided as a reward.

17. The method of claim 12, wherein the First User computing device and the Second User computing device are each a smart phone.

18. The method of claim 12, wherein the Second User updates his or her photo daily.

19. The method of claim 12, further including near field network connection between the First User computing device and Second Users having second instances of the application in receive funds mode within the pre-determined geographic proximity.

20. The method of claim 12, wherein the geographic locations of the First User and at least a subsection of the Second Users within the pre-determined geographic proximity are displayed to the First User through a mapping application.

21. The method of claim 20, wherein the mapping application has a user selected resolution, the pre-determined geographic proximity to the First User set at about the user selected resolution of the mapping application.

22. The method of claim 12, wherein the GPS location of each Second User having a second instance of the application in receive funds mode is sent to the first system at regular time intervals.

23. A system for permitting proximity based transfer of funds from a first person to a second person, comprising:
a remote server system having a processor and a database, the database having a user account for each user utilizing an instance of an application for proximity based funds transfer, each user account including financial transaction information, the current GPS location of the user, and for at least each account permitting receipt of funds, the account including a picture of the user;
at least one remote application for proximity based funds transfer (PBF App) for installation upon a remote user's first computing device having a processor and a GPS element, the remote application communicating GPS location information from the remote user device to the remote server system, the remote application having a first operating mode as a receiver permitting the receipt of funds and at least a second operating mode as a provider permitting the sending of funds;
wherein upon a First User, desiring to transfer funds to a Second User, requests from the remote server the location of at least one Second User device within a pre-determined geographic proximity of the First User computing device as determined by comparing GPS location records, the remote server sending to the First User device the GPS location and picture of each identified Second User within the pre-determined geographic proximity, the First User reviewing the provided pictures, and upon a selection of a Second User picture the First User specifying an amount of funds for sending to the selected Second User, the remote server receiving the specified amount of funds for sending and processing the transfer with the financial transaction information of the First User and the selected Second User.

24. The system of claim 23, wherein the pre-determined geographic proximity is about 500 feet.

25. The system of claim 23, wherein upon a transfer of funds, the remote server system notifies both the First User and the selected Second User of the transfer of funds.

26. The system of claim 23, wherein the use of pictures permits the First User to visually confirm the selected Second User as the desired party to receive the transferred funds.

27. The system of claim 23, wherein the transfer of funds are provided as a reward.

28. The system of claim 23, wherein the First User computing device and the Second User computing device are each a smart phone.

29. The system of claim 23, wherein the Second User updates his or her photo daily.

30. The system of claim 23, further including near field network connection between the First User computing device and Second Users having second instances of the application in receive funds mode within the pre-determined geographic proximity.

31. The system of claim 23, wherein the geographic locations of the First User and at least a subsection of the Second Users within the pre-determined geographic proximity are displayed to the First User through a mapping application.

32. The system of claim 31, wherein the mapping application has a user selected resolution, the pre-determined geographic proximity to the First User set at about the user selected resolution of the mapping application.

33. The system of claim 23, wherein the GPS location of each Second User having a second instance of the application in receive funds mode is sent to the first system at regular time intervals.

34. A computer system having at least one physical processor and memory adapted by software instructions to permit proximity based transfer of funds from a first person to a second person, comprising:
an I/O module operatively associated with an input/output device for receiving a request to establish a user account within a database, the I/O module further permitting receipt of financial transaction information and the current GPS location of the user, and for at least each account permitting receipt of funds, the account including a picture of the user;
a proximity determining module for comparing the GPS locations of users as noted in the database to determine at least one subset of users within a pre-determined geographic proximity to one another;
a receiver/provider module permitting a user to specify that he or she is currently in a receive funds or transfer funds mode;
a display location module for displaying to a requesting First User the locations of at least a subset of Second Users who are within a pre-determined geographic proximity to the First User;
a selection module permitting the First User to select at least one geographically proximate Second User, the selection module further presenting the First User with the picture of the selected Second User as provided by the database; and
a funds transfer module for transferring funds as specified by the First User to the selected Second User based on the financial transaction information associated with the First User and selected Second User in the database.

35. The computer system of claim 34, wherein the pre-determined geographic proximity is about 500 feet.

36. The computer system of claim 34, wherein the use of pictures permits the First User to visually confirm the selected Second User as the desired party to receive the transferred funds.

37. The computer system of claim 34, wherein the transfer of funds are provided as a tip.

38. The computer system of claim 34, wherein the Second User updates his or her photo daily.

39. The computer system of claim 34, wherein the GPS location of each Second User permitting receipt of funds is sent to the updated in the database at regular time intervals.

40. The computer system of claim 34, wherein the display location module provides a user scalable map, the pre-determined geographic proximity to the First User set at about the user selected scale of the map.

41. The computer system of claim 34, wherein upon a transfer of funds, the remote server system notifies both the First User and the selected Second User of the transfer of funds.

42. The computer system of claim 34, wherein each user has a remote computing device having a processor and a GPS module operating to determine the user's current GPS location and report the determined location to the database, each user device having at least an instance of the receiver/provider module, the display locations module and the selection module, each user device in remote communication with a server computer system having at least an instance of the input module, the proximity determining module and the funds transfer module.

43. The computer system of claim 42, wherein the remote computing device of each user is a smart phone.
